(19) United States
(12) Patent Application Publication
(10) Pub. No.: US 2005/0201419 A1
(43) Pub. Date: Sep. 15, 2005

(54) System and associated terminal, method and computer program product for synchronizing distributively presented multimedia objects

(75) Inventor: Mark R. Adler, Lexington, MA (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/797,210

(22) Filed: Mar. 10, 2004

(51) Int. Cl. H04J 3/06

(52) U.S. Cl. 370/503; 370/350

(57) ABSTRACT

A system is provided for synchronizing distributively presented multimedia objects. The system includes a processing element, as such may be part of a primary communication system. The processing element is capable of sending audio to a mobile terminal over an audio channel, where the audio includes at least one coded tone. The coded tone(s) can be representative of at least one multimedia object. In this regard, the processing element is capable of sending the audio such that, when the audio includes at least one coded tone, the mobile terminal is capable of decoding the coded tone(s) to thereby identify the multimedia object(s) represented by the coded tone(s). Thereafter, the mobile terminal can be driven to present the identified multimedia object(s).

### FIELD OF THE INVENTION

The present invention generally relates to systems and methods for synchronizing images and, more particularly, to systems and associated terminals, methods and computer program products for synchronizing distributively presented multimedia objects.

### BACKGROUND OF THE INVENTION

Where mobile telephones were perhaps viewed by many as a luxury when first introduced into the marketplace, they are today viewed by our society as very important, convenient, and useful tools. A great number of people now carry their mobile devices with them wherever they go. This popularity of wireless communication has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow audio communication, but also facilitate messaging, multimedia communications, e-mail, Internet browsing, and access to a wide range of wireless applications and services.

An incredible amount of content, applications, services, and the like is already available for use on wireless devices. However, the amount and types of information that will be accessible to mobile terminals will increase significantly in the coming years, as further technological advances will continue to diminish the gap between desktop and wireless systems. One conventional technique for sharing data among desktop systems, video conferencing, can comprise the simultaneous sharing of multimedia objects, such as images, as well as voice communication. More particularly, video conferencing techniques generally include a primary system originating or serving up multimedia objects, which can be received or otherwise presented by one or more distributed systems. More particularly, according to such techniques, users of the primary and distributed systems can engage in simultaneous voice communication with one another, such as across a public-switched telephone network. As users of the primary and distributed systems exchange voice communication, then, primary and distributed desktop systems can be operated to present a display of one or more multimedia objects simultaneous with the audio communication, such as in a presentation.

In accordance with such video conferencing techniques, multimedia objects presented by the primary and distributed systems can be synchronized in a number of different manners. In one typical technique, a user of the primary system can direct users of the distributed systems to synchronize the images of the distributed systems, such as via voice communication. For example, a user of the primary system can direct users of the distributed systems to synchronize the images by telling such distributed users the correct image to present (e.g., “Please turn to the next image.”). However, such a technique can impose an undesirable burden on the users of the primary and distributed systems. In this regard, the user of the primary system must remember to direct users of the distributed systems to synchronize the images, and in turn, users of the distributed systems must pay enough attention to synchronize the images once directed to do so. In another more advanced technique, then, the primary system communicates with the distributed systems across a data network to indicate the images presented by the primary system, or to transmit the images to the distributed systems, and direct the distributed systems to present the same images.

Whereas video conferencing techniques such as those indicated above are adequate for desktop systems, such techniques have drawbacks when one or more of the systems comprise mobile systems. In this regard, instances where the user of the primary system communicates with the users of distributed systems to synchronize the images, users of mobile distributed systems still face an undesirable burden of synchronizing the images. And because conventional mobile technology does not provide for simultaneous use of audio and data channels of mobile systems, conventional video conferencing techniques do not provide for simultaneous audio communication between users of the primary system and distributed systems, and data communication between the primary and distributed systems. In instances where the primary system communicates with the distributed systems across a data network to direct the distributed systems to present the images presented by the primary system, conventional mobile technology does not permit the simultaneous use of audio communication as is common in such techniques.

### SUMMARY OF THE INVENTION

In light of the foregoing background, embodiments of the present invention provide an improved system and associated terminal, method and computer program product for synchronizing distributively presented multimedia objects. The system and associated terminal, method and computer program product of embodiments of the present invention are capable of synchronizing distributively presented multimedia objects between a primary communication system and a terminal operating as a distributed communication system. In this regard, embodiments of the present invention are capable of synchronizing presentation of multimedia objects without requiring a user of the primary communication system to direct a terminal user to synchronize the presentation of the multimedia objects via voice communication. Also, embodiments of the present invention are capable of synchronizing presentation of multimedia objects in instances where the primary communication system and terminal exchange audio communication over an audio channel where synchronization information is passed over the audio channel, without requiring the use of a data channel over which the primary communication system would otherwise direct the terminal to synchronize the multimedia objects.

According to one aspect of the present invention, a system is provided for synchronizing distributively presented multimedia objects. The system includes a processing element, as such may be part of a primary communication system. The processing element is capable of sending audio to a mobile terminal over an audio channel, where the audio comprises at least one coded tone, and can additionally comprise voice communication. The coded tone(s) can be representative of at least one multimedia object. In this regard, the processing element is capable of sending the audio such that, when the audio comprises at least one coded tone, the mobile terminal is capable of decoding the coded tone(s) to thereby identify the multimedia object(s) represented by the coded tone(s). Thereafter, the mobile terminal can be driven to present the identified multimedia object(s).

The processing element can be capable of sending audio to the mobile terminal during an exchange of audio communication between the processing element and the mobile terminal over the audio channel. In such instances, the processing element can be further capable of presenting at least one multimedia object system as audio communication is exchanged with the mobile terminal. The processing element can therefore be capable of sending to the mobile terminal coded tone(s) representative of the multimedia object(s) presented at the processing element. More particularly, the processing element can be capable of sending the coded tone(s) representative of the multimedia object(s) presented by the processing element in response to presenting the multimedia object(s).

The processing element can be capable of sending the audio to the mobile terminal such that, when the audio comprises at least one coded tone, the mobile terminal is capable of retrieving, from memory, the identified multimedia object(s) before presenting the identified multimedia object(s). The processing element can be capable of sending at least one multimedia object to the mobile terminal over a data channel before sending audio to the mobile terminal over the audio channel. In such instances, the received multimedia object(s) include the identified multimedia object(s).

According to other aspects of the present invention, a terminal, method and computer program product are provided for synchronizing distributively presented multimedia objects. Therefore, embodiments of the present invention provide an improved system and associated terminal, method and computer program product for synchronizing distributively presented multimedia objects. The system and associated terminal, method and computer program product of embodiments of the present invention provide synchronization of distributively presented multimedia objects without requiring users of systems presenting the multimedia objects to communicate such synchronization via voice communication. In addition, embodiments of the present invention permit synchronization of distributively presented multimedia objects without requiring the use of a data channel over which the primary communication system can direct the terminal to synchronize the multimedia objects. Therefore, the system, and associated terminal, method and computer program product of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a communications system according to one embodiment of the present invention including a cellular network, a public-switched telephone network and a data network;

FIG. 2 is a schematic block diagram of a mobile station that may operate as a terminal, according to embodiments of the present invention;

FIG. 3 is a flowchart illustrating various steps in a method of synchronizing distributively presented multimedia objects, according to embodiments of the present invention; and

FIG. 4 is a functional block diagram of a typical scenario of a system implementing a method of synchronizing distributively presented multimedia objects, according to embodiments of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

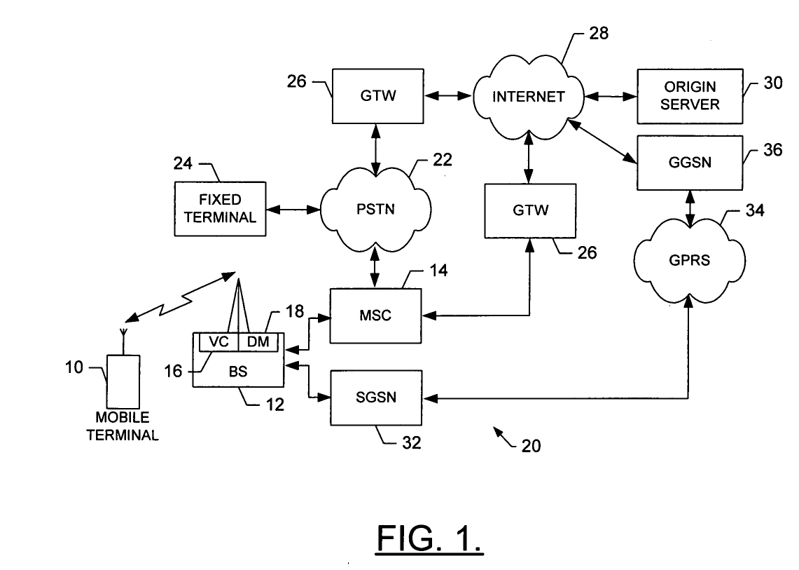

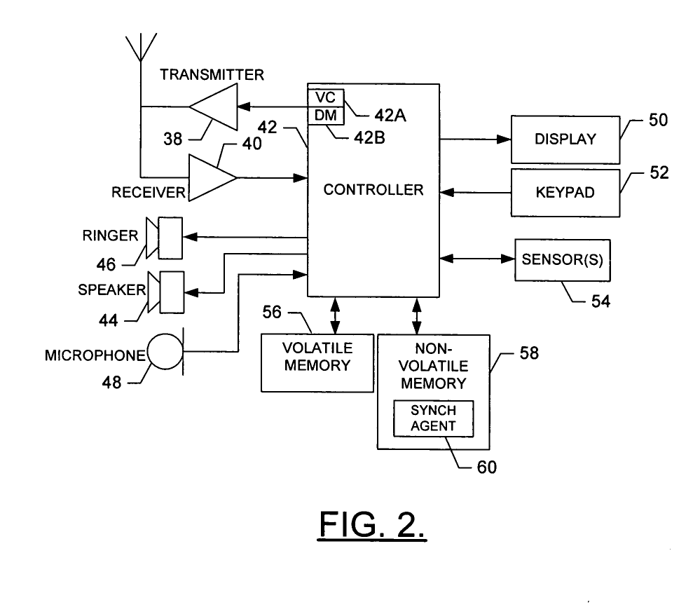

Referring to FIGS. 1 and 2, an illustration of one type of communications system and mobile terminal that would benefit from the present invention is provided. It should be understood, however, that the terminals illustrated and hereinafter described is merely illustrative of two types of terminals that would benefit from the present invention and, therefore, should not be taken to limit the scope of the present invention. The system and method of the present invention will be primarily described in conjunction with mobile communications applications. It should be understood, however, that the system and method of the present invention can be utilized in conjunction with a variety of other applications, both in the mobile communications industries and outside of the mobile communications industries.

As shown, a mobile terminal 10 is capable of transmitting signals to and receiving signals from a base site or base station (BS) 12. The base station is a part of a cellular network that includes a mobile switching center (MSC) 14, voice coder/decoders (vocoders) (VC) 16, data modems (DM) 18, and other units required to operate the cellular network. The MSC is capable of routing calls and messages to and from the mobile terminal when the mobile terminal is making and receiving calls. The MSC also controls the forwarding of messages to and from the mobile terminal when the terminal is registered with the cellular network, and controls the forwarding of messages for the mobile terminal to and from a message center (not shown). As will be appreciated by those skilled in the art, the cellular network may also be referred to as a Public Land Mobile Network (PLMN) 20.

The PLMN 20 is capable of providing audio communications in accordance with a number of different techniques. In this regard, the PLMN is capable of operating in accordance with any of a number of first-generation (1G), second-generation (2G), 2.5G and/or third-generation (3G) communication techniques, and/or any of a number of other cellular communication techniques capable of operating in accordance with embodiments of the present invention. For example, the PLMN can be capable of operating in accordance with GSM (Global System for Mobile Communication), IS-136 (Time Domain Multiple Access—TDMA), IS-95 (Code Division Multiple Access—CDMA), or EDGE (Enhanced Data GSM Environment) communication techniques. Within the PLMN, signaling communications may be provided in accordance with any of a number of different techniques, but signaling communications are typically provided in accordance with the Signaling System 7 (SS7) standard.

The MSC 14, and thus the PLMN 20, can be coupled to a Public Switched Telephone Network (PSTN) 22 that, in turn, is coupled to one, or more typically, a plurality of fixed terminals 24, such as wireline and/or wireless telephones. Like the PLMN, the PSTN is capable of providing signaling communications in accordance with any of a number of different techniques, including SS7. The PSTN is also capable of providing audio communications in accordance with any of a number of different techniques. For example, the PSTN may operate in accordance with Time Division Multiplexing (TDM) techniques, such as 64 Kbps (CCIT), and/or Pulse Code Modulation (PCM) techniques, such as 56 Kbps (ANSI).

The PLMN 20 (via the MSC 14) and the PSTN 22 can be coupled to a data network, such as a local area network (LAN), a metropolitan area network (MAN), and/or a wide area network (WAN). The PLMN and PSTN can be directly coupled to the data network. In one typical embodiment, however, each of the PLMN and PSTN is coupled to a GTW 26, and the GTW is coupled to a WAN, such as the Internet 28. In turn, devices such as processing elements (e.g., personal computers, server computers or the like) can be coupled to the mobile terminal 10 via the Internet. For example, the processing elements can include one or more processing elements associated with an origin server 22, as shown in FIG. 1.

In addition to the BS 12 and the MSC 14, the PLMN 20 can include a signaling GPRS (General Packet Radio Service) support node (SGSN) 32. As known to those skilled in the art, the SGSN is typically capable of performing functions similar to the MSC for packet-switched services. The SGSN, like the MSC, can be coupled to a data network, such as the Internet 28. The SGSN can be directly coupled to the data network. In a more typical embodiment, however, the SGSN is coupled to a packet-switched core network, such as a GPRS core network 34. The packet-switched core network is then coupled to a GTW, such as a GTW GPRS support node (GGSN) 36, and the GGSN is coupled to the Internet.

By coupling the SGSN 32 to the GPRS core network 34 and the GGSN 36, devices such as origin servers 30 can be coupled to the mobile terminal 10 via the Internet 28, SGSN and GGSN. In this regard, origin servers can provide content to the terminal, such as in accordance with the Multimedia Broadcast Multicast Service (MBMS). Also, for example, one or more origin servers can be capable of engaging in audio communication with the terminal, such as in accordance with voice over IP (VoIP) techniques, as such are well known to those skilled in the art. In such instances, the origin server(s) are capable of operating as a terminal with respect to the mobile terminal, much in the same manner as a fixed terminal 30.

FIG. 2 illustrates a functional diagram of a mobile station that may operate as a terminal 10, according to embodiments of the invention. It should be understood, that the mobile station illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of mobile stations, such as portable digital assistants (PDAs), pagers, laptop computers and other types of voice and text communications systems, can readily employ the present invention.

The mobile station includes a transmitter 38, a receiver 40, and a processor such as a controller 42 that provides signals to and receives signals from the transmitter and receiver, respectively. These signals include signaling information in accordance with the air interface standard of the applicable cellular system, and also user speech and/or user generated data. In this regard, the mobile station can be capable of operating with one or more air interface standards, communication protocols, modulation types, and access types. More particularly, the mobile station can be capable of operating in accordance with any of a number of 1G, 2G, 2.5G and/or 3G communication protocols or the like. For example, the mobile station may be capable of operating in accordance with 2G wireless communication protocols IS-136 (TDMA), GSM, and IS-95 (CDMA). Some narrow-band AMPS (NAMPS), as well as TACS, mobile stations may also benefit from embodiments of the present invention, as should dual or higher mode mobile stations (e.g., digital/analog or TDMA/CDMA/analog phones).

It is understood that the controller 42 includes the circuitry required for implementing the audio and logic functions of the mobile station. For example, the controller may be comprised of a digital signal processor device, a microprocessor device, and various analog to digital converters, digital to analog converters, and/or other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 42A, and may include an internal data modem (DM) 42B. Further, the controller may include the functionally to operate one or more software applications, which may be stored in memory.

The mobile station also comprises a user interface including a conventional earphone or speaker 44, a ringer 46, a microphone 48, a display 50, and a user input interface, all of which are coupled to the controller 42. The user input interface, which allows the mobile station to receive data, can comprise any of a number of devices allowing the mobile station to receive data, such as a keypad 52, a touch display (not shown) or other input device. In embodiments including a keypad, the keypad includes the conventional numeric (0-9) and related keys (#, *), and other keys used for operating the mobile station.

The mobile station may also have one or more sensors 54 for sensing the ambient conditions of the mobile user and, more particularly, the mobile station operated by, or otherwise under the control of, the mobile user. More particularly, the mobile station may include sensors such as, for example, an audio sensor. The audio sensor can in turn comprise, for example, a microphone as part of the user interface. In this regard, the audio sensor can detect speech or environmental sounds, audio or the like including voice or environmental sounds originating from the mobile station, such as from the speaker 44.

The mobile station can also include memory, such as volatile memory 56. Also, the mobile station can include non-volatile memory 58, which can be embedded and/or may be removable. The memories can store any of a number of pieces of information, and data, used by the mobile station to implement the functions of the mobile station. For example, the memories can store content, multimedia objects or the like. Also, for example, the memories can also store client applications such as a conventional Web browser, image and/or presentation viewer, image and/or presentation browser, or the like. Further, for example, the memories can store an application such as a synchronization agent (synch agent) 60 capable of synchronizing distributively presented multimedia objects, as explained further below. The applications are typically embodied in software, but as will be appreciated, one or more applications can alternatively be embodied in firmware, hardware or the like.

Although not shown, the mobile station can further include one or more means for sharing and/or obtaining data from electronic devices, such as another terminal 10, an origin server 22, a desktop computer system, a laptop computer system or the like, in accordance with any of a number of different wireline and/or wireless techniques. For example, the mobile station can include a radio frequency (RF) transceiver and/or an infrared (IR) transceiver such that the mobile station can share and/or obtain data in accordance with radio frequency and/or infrared techniques. Also, for example, the mobile station can include a Bluetooth (BT) transceiver such that the mobile station can share and/or obtain data in accordance with Bluetooth transfer techniques. The mobile station may additionally or alternatively be capable of transmitting and/or receiving data from electronic devices according to a number of different wireline and/or wireless networking techniques, including LAN and/or WLAN techniques.

As explained in the background section, conventional video conferencing techniques have drawbacks when one or more participating systems comprise mobile systems. In this regard, instances where the user of a primary system communicates with distributed systems to synchronize images, either by indicating the images presented by the primary system or transmitting the images presented by the primary system, users of mobile distributed systems still face an undesirable burden of synchronizing the images. And because conventional mobile technology does not provide for simultaneous use of audio and data channels of mobile systems, conventional video conferencing techniques do not provide for simultaneous audio communication between users of the primary system and distributed systems, and data communication between the primary and distributed systems, as would conventionally be desired for synchronization of the multimedia objects.

In accordance with embodiments of the present invention, then, a terminal 10 is capable of operating as a distributed communication system in a system that includes a primary communication system and one or more distributed communication systems, each being capable of exchanging audio communication with the primary communication system. The primary system, in turn, can include any of a number of processing elements, such as an origin server 30, laptop computer system, desktop computer system, PDA or the like, capable of presenting multimedia objects, such as textual, graphical, audio and/or video objects. For example, the processing element can be capable of presenting images from a presentation including a plurality of images. In addition to the processing element, the primary system can include a terminal, such as a fixed terminal 24, mobile terminal or the like, capable of exchanging audio communications with the terminal operating as a distributed system. Alternatively, the primary system can include a processing element capable of providing audio communication functionality.

Operating as a distributed system in the video conferencing system, the terminal 10 is likewise capable of receiving and presenting multimedia objects, such as images displayed by the primary system. The terminal can receive the multimedia objects in any of a number of different manners. For example, the terminal can receive the multimedia objects in accordance with RF, Bluetooth, infrared or any of a number of different wireline or wireless networking techniques, including local area network (LAN) or wireless LAN (WLAN) techniques. Irrespective of how the terminal receives the multimedia objects, the terminal is capable of storing the multimedia objects, such as in memory (e.g., non-volatile memory 58) of the terminal, and thereafter presenting the multimedia objects, such as during a video conference with the primary communication system.

In accordance with embodiments of the present invention, the primary and distributed communication systems are capable of exchanging audio communication, such as over an audio channel across a PLMN 20. For example, the primary and distributed communication systems can be capable of exchanging voice communication, such as to discuss one or more multimedia objects. During audio communication, then, the primary communication system is capable of presenting one or more multimedia objects, such as images in a presentation. In turn, a terminal 10, operating as a distributed communication system, is capable of presenting the same multimedia objects as the primary system in a manner at least partially in synch with the primary communication system. To properly present the multimedia objects, then, the terminal, or more particularly a synchronization agent 60 of the terminal, is capable of synchronizing multimedia objects presented by the terminal with multimedia objects presented by the primary communication system.

As will be appreciated, the synchronization agent 60 can synchronize the multimedia objects in a number of different manners. For example, in one particularly advantageous embodiment, during presentation of the multimedia objects and during audio communication between the primary and distributed communication systems, the primary communication system is capable of sending coded audio tones to the distributed systems over the audio channel. The coded audio tones represent one or more multimedia objects capable of being presented by the primary, and thus the distributed, communication systems. More particularly, the coded audio tones represent multimedia object(s) presented by the primary communication system, and can be sent by the primary communication system as the primary communication system presents the respective multimedia object(s).

The coded tones can represent multimedia object(s) in any of a number of different manners. For example, the decoded tones can be representative of an absolute or relative multimedia object. In this regard, the primary communication system can store a set of coded tones for a presentation including a number of sequential slides, each slide including one or more multimedia objects. In such an instance, each tone can be representative of relative multimedia object(s), where the set includes coded tones representative of the first slide, the previous slide, the next slide, the last slide or the like. Additionally, or alternatively, each tone can be representative of respective absolute multimedia object(s).

The coded tones can likewise be generated in any of a number of different manners, and at any of a number of different times. For example, the coded tones can be generated before the primary communication system presents the respective multimedia object(s) based upon input from a user of the primary system directing the primary system to present the respective multimedia object(s). In this regard, in one embodiment, the primary communication system can store a plurality of tones, such as in a library of tones, where different combinations of one or more tones have associated meanings (e.g., first slide, previous slide, next slide, last slide, etc.). In such instances, the primary communication system can generate the coded tones by selecting one or more of the tones from the library as the coded tones representative of the multimedia object(s) based upon the meaning associated with the selected tone(s). Irrespective of how and when the coded tones are generated, however, when the primary communication system presents multimedia object(s), the primary communication system is capable of generating and thereafter outputting coded tones representative of the multimedia object(s). The coded tones can then be capable of being sent to the distributed communication systems over an audio channel, such as during audio communication between users of the primary and distributed communication systems over the same audio channel.

A terminal 10 operating as a distributed communication system is capable of receiving the coded tones in addition to voice communication from the primary communication system. The terminal, or more particularly a synchronization agent 60 of the terminal, can then decode the coded tones. For example, like the primary communication system, the terminal can store a library of tones, combinations of which can have associated meanings. The synchronization agent, then, can decode the coded tones by determining the meaning of the coded tones by matching the coded tones with tones from the library of tones. Irrespective of how the synchronization agent decodes the coded tones, however, the synchronization agent can thereafter be capable of driving the terminal to present multimedia object(s) represented by the tones. By presenting the multimedia object(s) represented by the coded tones after receipt of the coded tones form the primary communication system (the primary communication system having sent the coded tones in response to presenting the same multimedia object(s)), the synchronization agent is capable of synchronizing multimedia object(s) displayed by the terminal with multimedia object(s) displayed by the primary communication system.

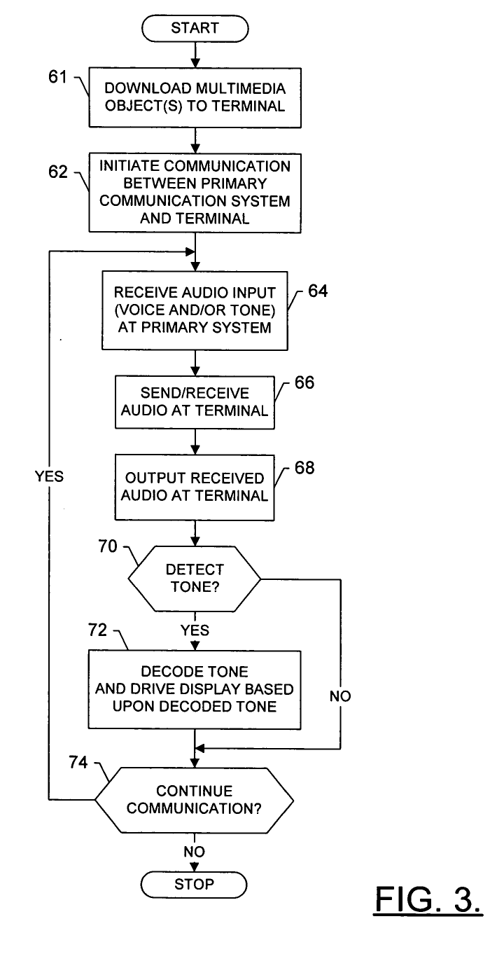

Reference is now made to FIG. 3, which illustrates various steps of a method of synchronizing distributively presented multimedia objects in accordance with one embodiment of the present invention. As shown in block 61, a method of synchronizing distributively presented multimedia objects includes downloading or otherwise transferring one or more multimedia objects from a primary communication system to a terminal 10 operating as a distributed communication system. Thereafter, as shown in block 62, the primary communication system and the terminal can initiate audio communication between the primary communication system and the terminal 10. More particularly, the method includes initiating audio communication between the primary communication system and a terminal over an audio channel across the PLMN 20. During audio communication, the primary communication system is capable of receiving audio input, as shown in block 64. The audio input can include voice communication from a user of the primary communication system. In accordance with embodiments of the present invention, however, the audio input can additionally or alternatively include one or more coded tones representative of one or more of the downloaded multimedia object(s). For example, as indicated above, the audio input can include coded tones when the primary communication system displays an image represented by the respective coded tones.

As the primary communication system receives audio input, the primary communication system is capable of sending the audio to the terminal 10, which is capable of thereafter receiving the audio, as shown in block 66. Upon receipt of the audio, the terminal is capable of outputting the audio, such as via a speaker (e.g., speaker 44), as shown in block 68. As the terminal outputs the audio, the synchronization agent 60 is capable of detecting whether the audio includes coded tones, as shown in block 70. The synchronization agent can detect coded tones in any of a number of different manners. In one typical embodiment, as the terminal outputs the audio, an audio sensor (e.g., sensor 54) of the terminal is capable of detecting the audio. In turn, the synchronization agent is capable of communicating with the audio sensor to receive the audio, including the coded tones.

Irrespective of how the synchronization agent 60 detects coded tones, if the synchronization agent detects coded tones in the audio output by the terminal 10, the synchronization agent is capable of decoding the coded tones to identify the multimedia object(s) represented by the coded tones, as shown in block 72. Thereafter, the synchronization agent is capable of driving the terminal to present the multimedia object(s) represented by the coded tones, such as via a display (e.g., display 50) of the terminal. More particularly, in one typical scenario, the synchronization agent can be capable of driving an application, such as an application capable of interpreting the multimedia object(s), to drive the terminal. In this regard, the synchronization agent and/or application can be capable of retrieving the multimedia object(s) from memory (e.g., non-volatile memory 58), and thereafter driving the terminal to present the multimedia object(s).

Irrespective of how the synchronization agent 60 drives the presentation of the multimedia object(s) represented by coded tones, audio communication between the primary communication system and the terminal 10 can continue, as shown in block 74. As will be appreciated, the audio communication can continue for any length of time, such as until the primary communication system or the terminal terminate the communication. During the audio communication session, however, the method can continue with the primary communication system sending audio to the terminal, and the terminal outputting the audio. Similarly, the method can continue with the synchronization agent 60 detecting coded tones and driving the terminal accordingly.

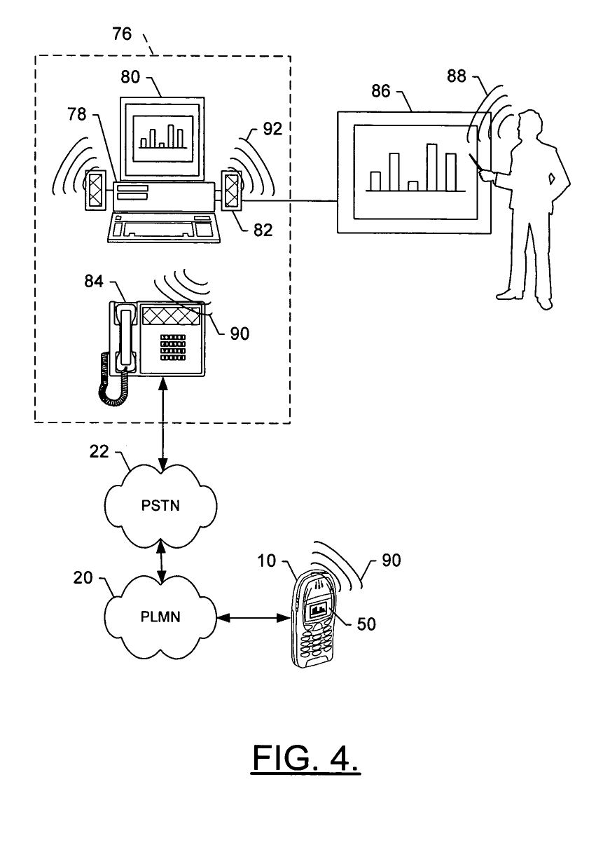

Reference will now be made to FIG. 4, which illustrates a functional block diagram of a typical scenario of a system implementing a method of synchronizing distributively presented multimedia objects, in accordance with one embodiment of the present invention. As shown, the system includes a primary communication system 76 capable of communicating with a terminal 10 operating as a distributed communication system, where the primary communication system and terminal communicate over an audio channel across a PLMN 20 and a PSTN 22. It should be understood, however, that the primary communication system and the terminal could equally communicate over an audio channel across a PLMN and a data network (e.g., Internet 28), such as in accordance with VoIP techniques.

As shown, the primary communication system 76 includes a processing element such as a desktop computer system, which includes a central processing unit (CPU) 78, a display 80 and a means for outputting audio, such as one or more speakers 82. In addition, the primary communication system includes a fixed terminal, such as a wireline and/or wireless telephone 84, for facilitating audio communication between a user of the primary communication system and a user of the terminal.

In the scenario illustrated in FIG. 4, consider a user of the primary communication system 76 giving a presentation to a plurality of participants located within a viewing area of the user of the primary communication system. In this regard, the processing element is capable of operating an application, such as Microsoft® PowerPoint®, to drive the display 80 to present a multimedia presentation including one or more slides, each slide including one or more multimedia objects. The processing element, in turn, can be coupled to a projector 86 or the like capable of presenting graphical objects of the slides of the presentation in an enlarged format, such as for viewing by the plurality of participants.

Consider that simultaneous with the presentation to the participants located within a viewing area of the user of the primary communication system 76, the presentation is simultaneously given to a number of users of distributed communication systems, at least one of which is a user of a mobile terminal 10. The terminal user can therefore listen to the presentation given by the user of the primary communication system by initiating audio communication with the primary communication system, or more particularly the wireline and/or wireless telephone 84 of the primary communication system, over an audio channel. The terminal user can also view the multimedia presentation on a display (e.g., display 50) of the terminal. For example, the terminal can view the multimedia presentation executing a presentation viewer and recalling the multimedia presentation, including each of the slide(s) of the presentation, from memory (e.g., non-volatile memory 58). In this regard, the terminal can receive the multimedia presentation, for example, from the primary communication system over a data channel before engaging in audio communication with the primary communication system over the audio channel.

Irrespective of how the terminal 10 receives and stores the multimedia presentation, as the user of the primary communication system 76 gives the presentation, terminal user can view the multimedia presentation on a display of the terminal. Simultaneously, the terminal user can listen to the user of the primary communication system across the audio channel between the fixed terminal 84 and the terminal. In this regard, during the presentation, the user of the primary communication system outputs voice communication 88. The voice communication can thereafter be received as input audio 90 by the primary communication system, or more particularly the fixed terminal. The fixed terminal can then pass the audio across the audio channel to the terminal, which can thereafter output the audio 90 from the terminal, or more particularly from a speaker (e.g., speaker 44).

At one or more points in time, as the slides of the multimedia presentation are presented by the primary communication system 76, the primary communication system can generate and thereafter output coded tones 92 representative of the respective slides, or more particularly the multimedia object(s) of the respective slides. Like the voice communication, the coded tones can be received along with voice communication as input audio 90 by the fixed terminal 84 of the primary communication system. The fixed terminal can then pass the audio, including the coded tones and voice communication, across the audio channel to the terminal 10. The terminal can thereafter output the audio 90 from a speaker (e.g., speaker 44), which can be detected by the synchronization agent 60, such as via an audio sensor (e.g., sensor 54). The synchronization agent can thereafter decode the tones to identify image(s) of the multimedia presentation, and drive the display of the terminal to present the respective image(s). More particularly, the synchronization agent can drive the presentation viewer which, in turn, can drive the display. The synchronization agent can thus synchronize the images displayed by the terminal with those images displayed by the primary communication system during the presentation.

According to one aspect of the present invention, all or a portion of the system of the present invention, such all or portions of the terminal 10, generally operates under control of a computer program product (e.g., synchronization agent 60). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 3 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the block(s) or step(s) of the flowchart. These computer program instructions may also be stored in a computer-readable memory that can direct a computer or other programmable apparatus to function in a particular manner, such that the instructions stored in the computer-readable memory produce an article of manufacture including instruction means which implement the function specified in the block(s) or step(s) of the flowchart. The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block(s) or step(s) of the flowchart.

Accordingly, blocks or steps of the flowchart support combinations of means for performing the specified functions, combinations of steps for performing the specified functions and program instruction means for performing the specified functions. It will also be understood that each block or step of the flowchart, and combinations of blocks or steps in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A system for synchronizing at least one distributively presented multimedia object, the system comprising:
a processing element capable of sending audio to a mobile terminal over an audio channel, wherein the audio comprises at least one coded tone, the at least one coded tone being representative of at least one multimedia object, and wherein the processing element is capable of sending the audio such that, when the audio comprises at least one coded tone, the mobile terminal is capable of decoding the at least one coded tone to thereby identify the at least one multimedia object represented by the at least one coded tone, and thereafter being driven to present the identified at least one multimedia object.

2. A system according to claim 1, wherein the processing element is capable of sending audio to the mobile terminal during an exchange of audio communication between the processing element and the mobile terminal over the audio channel.

3. A system according to claim 2, wherein the processing element is further capable of presenting at least one multimedia object system as audio communication is exchanged with the mobile terminal, and wherein the processing element is capable of sending to the mobile terminal at least one coded tone representative of the at least one multimedia object presented at the processing element.

4. A system according to claim 3, wherein the processing element is capable of sending the at least one coded tone representative of the at least one multimedia object presented by the processing element in response to presenting the at least one multimedia object.

5. A system according to claim 1, wherein the processing element is capable of sending the audio to the mobile terminal such that, when the audio comprises at least one coded tone, the mobile terminal is capable of retrieving, from memory, the identified at least one multimedia object before presenting the identified at least one multimedia object.

6. A system according to claim 5, wherein the processing element is capable of sending at least one multimedia object to the mobile terminal over a data channel before sending audio to the mobile terminal over the audio channel, the received at least one multimedia object including the identified at least one multimedia object.

7. A terminal comprising:
a controller capable of receiving audio over an audio channel, wherein the audio comprises at least one coded tone, the at least one coded tone being representative of at least one multimedia object, wherein the controller is capable of communicating with a synchronization agent such that, when the audio comprises at least one coded tone, the synchronization agent is capable of decoding the at least one coded tone to thereby identify the at least one multimedia object represented by the at least one coded tone, and thereafter driving the controller to present the identified at least one multimedia object.

8. A terminal according to claim 7, wherein the controller is capable of receiving audio during an exchange of audio communication between a primary communication system and the mobile terminal over the audio channel.

9. A terminal according to claim 8, wherein the controller is capable of receiving audio including at least one coded tone representative of at least one multimedia object presented by the primary communication system during the exchange of audio communication between the primary communication system and the mobile terminal.

10. A terminal according to claim 9, wherein the controller is capable of receiving the at least one coded tone from the primary communication system, the primary communication system having sent the at least one coded tone in response to presenting the at least one multimedia object.

11. A terminal according to claim 7 further comprising:
memory capable of storing at least one multimedia object,
wherein the controller is capable of retrieving, from the memory, the identified at least one multimedia object before presenting the identified at least one multimedia object.

12. A terminal according to claim 11, wherein the controller is capable of receiving, and thereafter storing in the memory, at least one multimedia before receiving audio at the mobile terminal, the received at least one multimedia object including the identified at least one multimedia object.

13. A method of synchronizing at least one distributively presented multimedia object, the method comprising:
receiving audio at a mobile terminal over an audio channel, wherein the audio comprises at least one coded tone, the at least one coded tone being representative of at least one multimedia object; and when the audio comprises at least one coded tone,
decoding the at least one coded tone to thereby identify the at least one multimedia object represented by the at least one coded tone; and
driving the mobile terminal to present the identified at least one multimedia object.

14. A method according to claim 13, wherein receiving audio comprises receiving audio during an exchange of audio communication between a primary communication system and the mobile terminal over the audio channel.

15. A method according to claim 14 further comprising:
presenting at least one multimedia object at the primary communication system during the exchange of audio communication between the primary communication system and the mobile terminal,
wherein receiving audio at the mobile terminal comprises receiving at least one coded tone representative of the at least one multimedia object presented at the primary communication system.

16. A method according to claim 15, wherein receiving at least one coded tone representative of the at least one multimedia object presented at the primary communication system comprises receiving the at least one coded tone from the primary communication system, the primary communication system having sent the at least one coded tone in response to presenting the at least one multimedia object.

17. A method according to claim 13 further comprising:
retrieving, from memory of the mobile terminal, the identified at least one multimedia object before presenting the identified at least one multimedia object.

18. A method according to claim 17 further comprising:
receiving at least one multimedia object at the mobile terminal before receiving audio at the mobile terminal, the received at least one multimedia object including the identified at least one multimedia object.

19. A computer program product for synchronizing at least one distributively presented multimedia object, the computer program product comprising at least one computer-readable storage medium having computer-readable program code portions stored therein, the computer-readable program code portions comprising:
a first executable portion for receiving audio at a mobile terminal over an audio channel, wherein the audio comprises at least one coded tone, the at least one coded tone being representative of at least one multimedia object;
a second executable portion for decoding the at least one coded tone to thereby identify the at least one multimedia object represented by the at least one coded tone when the audio comprises at least one coded tone; and
a third executable portion for driving the mobile terminal to present the identified at least one multimedia object when the audio comprises at least one coded tone.

20. A computer program product according to claim 19, wherein the first executable portion is adapted to receive audio during an exchange of audio communication between a primary communication system and the mobile terminal over the audio channel.

21. A computer program product according to claim 20 further comprising:
a fourth executable portion for presenting at least one multimedia object at the primary communication system during the exchange of audio communication between the primary communication system and the mobile terminal,
wherein the first executable portion is adapted to receive at least one coded tone representative of the at least one multimedia object presented at the primary communication system.

22. A computer program product according to claim 21, wherein the first executable portion is adapted to receive the at least one coded tone from the primary communication system, the primary communication system having sent the at least one coded tone in response to the fourth executable portion presenting the at least one multimedia object.

23. A computer program product according to claim 19 further comprising:
a fourth executable portion for retrieving, from memory of the mobile terminal, the identified at least one multimedia object before presenting the identified at least one multimedia object.

24. A computer program product according to claim 23 further comprising:
a fifth executable portion for receiving at least one multimedia object at the mobile terminal before the first executable portion receives audio at the mobile terminal, the received at least one multimedia object including the identified at least one multimedia object.
